(19) United States
(12) Patent Application Publication
(10) Pub. No.: US 2008/0150977 A1
(43) Pub. Date: Jun. 26, 2008

(54) Inkjet Printer Driver Circuit Architecture

(75) Inventor: Geoffrey P. Harvey, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XAARJET LIMITED, Cambridge (GB)

(21) Appl. No.: 11/911,093

(22) PCT Filed: Mar. 23, 2001
(86) PCT No.: PCT/GB06/01069

§ 371 Date: Dec. 19, 2007

(30) Foreign Application Priority Data
Apr. 8, 2005 (GB) 0507193.1

(51) Int. Cl. B41J 29/38

(52) U.S. Cl. 347/9

(57) ABSTRACT

A driver circuit for driving an array of inkjet printer actuators, comprising a serial input (15, 20) for receiving serial print data, a register (25, 26) for storing the print data in the form of event and event timing data pairs, a parallel output (30, 32) for outputting event data and control circuitry (42, 48) for controlling the timing of output of event data according to corresponding event timing data. The driver circuit preferably comprises a programmable part (10) and a fixed part (11, 12, 13, 14), in which the programmable part stores selectable pre-programmed waveforms and outputs event and time data pairs to the fixed circuit part, which controls the timing of output of the event data.

### FIELD OF THE INVENTION

This invention relates to a new architecture for an inkjet printer driver chip capable of very flexible waveform definition and line-by-line trim capability.

### BACKGROUND TO THE INVENTION

Piezo-electric actuators typically comprise two electrodes between which is an element formed from a piezo material such as PZT (Lead Zirconate Titanate). The electrodes apply an electric field to the material into is induced a small mechanical strain due to the piezo effect. In the field of piezo-electric inkjet printing, one or more small piezo-electric actuators cause the volume of an ink chamber to change momentarily, causing a pressure change within the chamber, that, when large enough, can result in the ejection of a droplet of ink through a nozzle communicating with the chamber, the droplet being ejected toward the printing paper or substrate. Often the piezo-actuators themselves form one or more of the side walls of the chamber.

In the field of high quality drop-on-demand inkjet printing, typically an array of inkjets are configured side by side and traverse the paper or substrate to print a swathe of ink. It is desirable that all inkjets fire substantially the same volume droplets of ink at substantially the same velocity, especially when such a swathe is to be printed in a constant colour or density. Variations in velocity can cause the droplets to land slightly displaced from the intended position, whilst variations in volume cause variations in print density. The human eye is very sensitive at perceiving any variations. Although each inkjet is nominally identical, such variation can be caused by a variety of factors.

Piezo actuators are typically driven by driver circuits which apply a particular voltage across the electrodes causing the actuator to move. An example of a driver circuit is HV3418 available from Supertex Inc., which is a 64-channel serial-to-parallel converter with high voltage push-pull outputs. That circuit has a 64-bit shift register, 64 latches and control logic to perform polarity select and blanking of the outputs.

A problem with existing drivers is that they have no capability or limited ability to control actuators individually, and especially they are not able to incorporate fine adjustments to individual actuators to account for factors that give rise to variations between individual nozzles, such as variations that arise from normal manufacturing tolerances. To the extent that existing drivers may allow limited capability to control actuators individually, many aspects of such control are hardwired into the driver, limiting the ease with which such drivers can be adapted to the requirements of rapidly evolving printhead design.

### SUMMARY OF THE INVENTION

In accordance with the present invention, a driver circuit is provided for driving an array of inkjet printer actuators. The circuit has a serial input for receiving serial print data, at least one register for storing the print data in the form of event and event timing data pairs, and a parallel output for outputting event data. Control circuitry controls the timing of output of event data according to corresponding event timing data.

In accordance with another aspect of the invention, a driver circuit for driving an array of inkjet printer actuators is provided which comprises, together and individually, first and second circuit parts. The first part is programmable and has an input for receiving print data, storage means for storing selectable pre-programmed waveforms in the form of event and timing data, and an output for outputting event and time data pairs based upon the print data and the pre-programmed waveforms. The second part has a register for receiving and storing event and time data pairs, a parallel output for outputting event data, and control circuitry for controlling the timing of output of event data according to corresponding event timing data.

A preferred embodiment of the invention is now described, by way of example only, with reference to the drawings.

### BRIEF DESCRIPTION OF THE DRAWINGS

FIG. 1 is a block diagram of a driver architecture in accordance with the preferred embodiment of the invention.

FIG. 2 shows the internal architecture of the driver ASIC of FIG. 1

FIG. 3 is a block diagram illustrating a driver and output stage for a single channel.

FIG. 4 is a time diagram illustrating a typical waveform for firing an individual inkjet channel actuator; and

FIG. 5 illustrates a conceptual model of FPGA logic for a single channel.

### DETAILED DESCRIPTION OF THE DRAWINGS

FIG. 1 shows the overall architecture of a driver in accordance with the preferred embodiment. It consists of a field programmable gate array (FPGA) 10 collected to four high voltage drivers 11, 12, 13, 14, each implemented in an application specific integrated circuit (ASIC). The FPGA 10 has a data input 15 to receive hexadecimal data representing the image to be printed. The FPGA 10 converts this data into individual pixel data for line-by-line printing by the inkjet printer. The individual pixel data is coded in a coding scheme based on data pairs comprising Event and Event_time values. An Event is an instruction to change an actuator driver state. For example to change from pull-down to pull-up with a particular slew rate and voltage clipping level attached. An Event_time is a binary coded time at which this is to happen. The Event_time can be coded to 10 ns resolution. The data pairs are delivered to the various driver ASICs 11 to 14. Since waveforms to be applied to individual actuator electrode are individually specified by a series of such Event and Event_time pairs, the logical structure of, and relationship between the group of waveforms applied to an array of actuators as a whole, is substantially defined and controlled by the FPGA and not the driver ASICs. Therefore, by way of reprogramming the FPGA, the architecture has an inherent adaptability to changing waveform requirements and to differing methods of compensating variations that occur between nozzles.

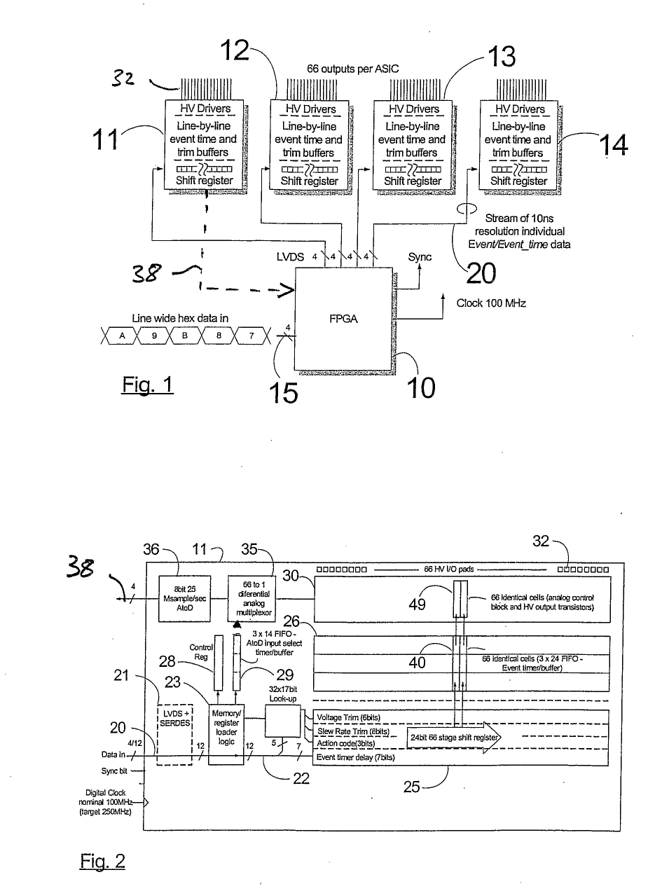

Referring to FIG. 2, the internal structure of each ASIC 11 to 14 in driver mode is illustrated. Each ASIC comprises an input 20 to receive the Event and Event_time pairs from the FPGA 10. The input 20 is preferably four bits wide at 300 MHz, but could have 12 bits at 100 MHz (an optional low voltage differential signalling (LVDS) and serializer/deserializer (SERDES) circuit 21 is shown, depending on the selected bus width). The data is input into an internal bus 22 through 2-stage memory/register loader logic 23. Connected to the bus 22 is a 32×17 bit lookup table memory 24 and a 24-bit 66-stage shift register 25. Also coupled to the register loader logic 23 are a control register 28 and a 3×14 FIFO timer/buffer 29.

Logically, data from input 20 passes through register/memory loader logic 23 to feed shift register 25, which acts as a serial-to-parallel converter. (Together therefore, elements 23 and 25 comprise a 68-long shift register.) Shift register 25 is connected in parallel to a bank of 66 identical 24-wide by 3-deep FIFO registers 26. The bank of registers 26 is in turn connected in parallel to a 66-bit-wide high voltage output stage 30, which is connected to 66 high-voltage output pads 32.

In operation, data words consisting of a seven bit Event_time and a five bit Event are clocked into the data bus 22. The five bit Event code is expanded to 17 bits via the lookup table 24 by adding voltage trim (6 bits), slew rate trim (8 bits) and an action code (3 bits). The trim formula provides data to control drop volume and velocity independently for each output nozzle and allows each trim setting to be expanded to an appropriate combination of slew rate and voltage trim to give higher precision.

The expanded input data is shifted into the 66-stage register 25. Data in register 25 advances until it is aligned with output pads 32 and is framed by a synchronisation input which is active every 68 clocks. It is then transferred into the bank of FIFO registers 26

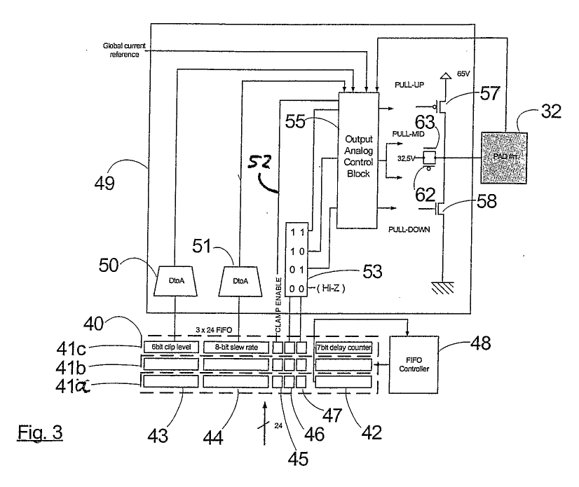

With every synchronisation pulse, a complete set of data is ready to be loaded by the bank of FIFO registers 26, which internally contains one identical element 40 for each output pin. The structure of each of these FIFOs is shown in greater detail in FIG. 3.

Before describing the FIFOs in greater detail, reference is made to elements shown in the upper-left hand portion of ASIC 11, in FIG. 2. Coupled to the memory/register loader logic 23 are shown a 3-stage control register 28 and a 3-stage A/D input select timer/buffer. The former is optional. The latter is connected to a 66-to-1 analog multiplexer (preferably a differential analog multiplexer), which has a 66-bit-wide input from the output stage 30 and an analog output to a 8-bit 25 Msamples/second A/D converter 36. The A/D converter 36 provides a digital feedback signal to the FPGA 10.

In operation of these elements, the A/D input select timer/buffer 29 controls selection in turn of each of the 66 analog outputs from the output stage 30 for connection to the A/D converter 36. When each output is in turn connected to the A/D converter, a digital reading of that output is provided on output 38 for analysis by the FPGA 10, or for FPGA 10 to pass to other data processing equipment for analysis. This is particularly useful for features such as temperature measurement, or analysis of reflections in the inkjet printer actuators (as described in co-pending patent application GB0506307.8 “Improved Piezo-Electric Ink Jet Driver with Active and Passive Impedance Adaptation and Motion Feedbak Control and Monitoring”) or for analysis of actuator resonant frequencies or associated resonant Q-factors (as described in co-pending patent application GB0506302.9 “Simplified method for establishing drop volume and drop velocity correction requirements in drop-on-demand ink jet printing apparatus”).

FIG. 3 shows an individual cell 40 containing registers 41a, 41b and 41c. One cell receives 24 bits (the seven bit event time and the 17 bits of expanded event code). The seven bits of event time are clocked through a seven-bit delay counter portion 42 of the FIFO cell 40. The 17 bits of expanded event data are clocked into a 6 bit clip level portion 43, an 8-bit output current portion 44, a clamp enable portion 45 and first and second voltage rail control bits 46 and 47. These various portions of the output to the FIFO cell 40 are coupled to D-to-A converters 50 and 51, a clamp enable line 52 and a two-bit demultiplexer 53 respectively, all contained within output stage 49. These various elements are in turn coupled to an output analog control block 55, also within output stage 49.

Control block 55 is coupled to pull-up and pull-down transistors 57 and 58 respectively, these transistors being connected between a 65v positive supply rail and ground. Transistors 57 and 58 have a mid-connection which is connected to an output pad 32. Also connected to output pad 32 are pull-mid transistors 62 and 63, which are coupled to a mid-rail voltage of 32.5 volts.

In operation, six bits of clip level data are clocked through FIFO portion 43 into D-to-A converter 50, and the analog equivalent is applied by control block 55 to transistors 57 and 58 to cause a selected voltage to be applied to pad 32. Similarly, 8 bits of slew rate control are clocked through FIFO portion 44 and D-to-A converter 51, and output analog control block 55 causes a controlled slew rate to be applied to voltage transition of pad 32. Control bits 45, 46 and 47 determine the switching state to which pad 32 needs to be switched, e.g. high, low, mid rail and high-impedance. For each event, a delay counter 42 records the precise time at which the transition is to occur.

Coupled to the delay counters 42 is a further FIFO controller 48 which maintains circular read and write pointers to the three corresponding 24-bit register arrays 41a, 41b & 41c. The lower seven bits of each register are “live” down-counters continually counting down. When the counter at the head of the queue expires, it allows the read pointer to advance, and new data to be read out of the associated registers freeing them to buffer more data on the next sync pulse. When the FIFO is implemented as a circular buffer as described, the data in registers 41a, 41b and 41c does not need to be physically moved during its logical progression through the FIFO. (As an alternative, however, the data can be parallel shifted through the FIFO so that register 41a always receives the serial data and register 41c always outputs the parallel data to the output pads 32.)

Whenever the FIFO read pointer advances, it allows new data to be presented to the output stage. The code tells the output buffers which voltage rail to pull toward, or whether to turn all buffers off for a high impendence state. As already mentioned, eight bits are binary codes for current drive strength or slew rate control, and six bits are for voltage clipping level. Each transition can therefore be controlled in its start time, slew rate and final voltage. A further “clamp enable” signal causes an output to turn on very hard to clamp inactive electrodes to ground in shared-wall actuators.

The relative allocation and total number of bits for clipping level and slew rate are not essential, and different allocations can be designed, depending on factors such as which of two voltage trim options are decided upon (see below).

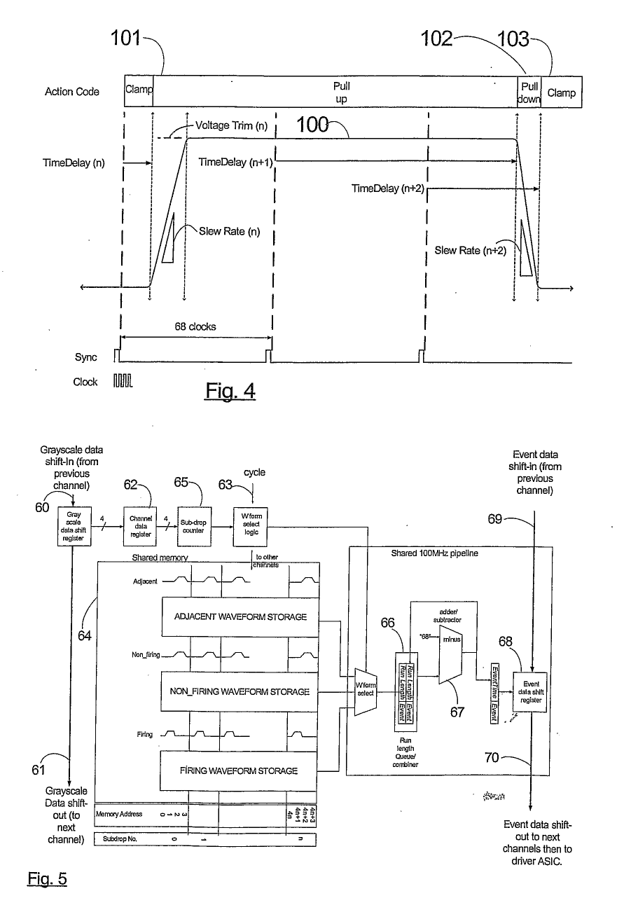

FIG. 4 shows how a complete ink jet actuator pulse 100 can be encoded. In this case a pulse is shown requiring three Events: a pull-up event 101 at time delay (n), a pull-down event 102 at time delay (n+1); and a clamp event 103 at time delay (n+2). Each Event happens at the time of the Sync pulse which transmitted it, delayed by the value of the 7-bit delay counter. Since the maximum delay is nearly twice the interval between sync pulses, an Event notionally belonging to one sync period can be delayed into the next (for example event 102), allowing up to two queued events to occur within the same sync period as shown (one purpose of the FIFO is to decouple the rate of input data from the rate of output data to allow this to happen). The coding method has the advantage that it cannot accumulate errors as might be the case with simple run-length coding. This makes the coding method quite robust in a noisy environment.

FIG. 5 shows a conceptual model of example FPGA logic for one of each of the 66 channels to be controlled. (Although the resources shown in FIG. 5 are for a single channel, in reality the memory storage and much of the logic can be shared on a time division basis.) Data bus 60 shifts greyscale print data in from a previous identical circuit and outputs the same data on the next clock edge to a successive channel via data bus 61. If the data so shifted is correctly aligned so that it is the print data for the particular channel shown, then the print data is transferred to channel data register 62. The print data in combination with print cycle identifying signal 63 and optional greyscales subdrop counter 65 determines which waveform of a number of alternative waveforms to apply to the actuator. Shared memory block 64 stores three waveform definitions in the form of Event/RunLength pairs, where Event is typically in the same format as described previously in relation to Event/EventTime pairs.

A number of alternative waveform definitions can be stored. For example in so-called shared-wall architecture print heads, only one third of actuators can be fired at any one time. This requires each actuator electrode to be driven by one of three alternative waveforms. A first possible waveform, the firing waveform is used when a channel is at a point in a complete firing cycle where it can eject a droplet (provided the print data demands ejection of a droplet). A second possible waveform, the non-firing waveform is used when a channel is at a point in a complete firing cycle where it may eject a droplet but the print data does not demand ejection of a droplet. A third possible waveform, the adjacent waveform, is used when a channel is at a point in a complete firing cycle where it is never required to eject a droplet but is physically adjacent to one which may.

In binary printing the print data directly controls whether the firing or non-firing waveform is alternatively chosen for a channel that may conditionally eject a droplet. In greyscale printing, a binary greyscale value determines how many sub-drops (for example between 0 and 15) are ejected in rapid succession. The function of subdrop counter 65 is to count the number of sub-drop ejected.

In the example of FIG. 5, three blocks of Event/RunLength pairs are stored in sequential memory A run-length group can comprise a constant number of Event/RunLength pairs (e.g. (2, 3, 4 or 5 or more) needed to code each successive sub-drop waveform). A combination of greyscale data and cycle is used to determine which of the three alternative waveforms to apply in any given sub-drop period. The necessity to be able to switch waveform selection between sub-drop periods means that run-length groups preferably always start and finish at sub-drop boundaries or at the same point in time during a sub-drop period. This requirement leads to some inefficiency, purely from a waveform encoding perspective, since additional Event/RunLength pairs are required to “top and tail” each sub-drop period (except where a waveform would already have had an Event on a sub-drop boundary). To avoid unnecessary bandwidth burden on the data channel 20, from the FPGA to the driver ASIC, the RunLength queue/combiner pipe shown in FIG. 5 identifies when two successive Event/RunLength pairs code the same Event and combines them by adding the run-lengths. An adder/subtractor 67 then “chips away at” the resulting run-length by subtracting 68 every Sync pulse time. While there remains more than value 128 as numeric remainder in the run length register, the same Event is repeatedly output into the Event data shift register with EventTime set to zero. When there is less than 128 remaining, the numeric remainder is output as EventTime with the next Event in the queue and the queue is advanced.

This mechanism produces the Event/EventTime data expected by the driver ASIC, and this data is loaded into Event Data Shift Register 68 which forms part of a parallel-to-serial converter shift register along with the other identical channel circuits (not shown) and from which data can be shifted out to the driver ASIC.

It will, of course, be understood that the embodiment described has been given by way of example only, and that numerous and varied modifications can be made within the scope of the invention.

I claim:

1. A driver circuit for driving an array of inkjet printer actuators, comprising: a serial input for receiving serial print data; a register for storing the print data in the form of event and event timing data pairs; a parallel output for outputting event data; and control circuitry for controlling the timing of output of event data according to corresponding event timing data.

2. A driver circuit in accordance with claim 1, further comprising a lookup memory for storing trim data for individual actuators.

3. A driver circuit in accordance with claim 2, wherein trim data for a given actuator is combined with event data for that actuator for adjustment of the event data each time event data is to be output to that actuator.

4. A driver circuit in accordance with claim 1, comprising a plurality of registers in a parallel first-in-first-out configuration for outputting one set of event data in parallel from one register while inputting a later set of event data in series to another register.

5. A driver circuit in accordance with claim 4, comprising at least three registers in a parallel first-in-first-out configuration, wherein, in a given sync cycle, one register receives event data in series, one register stores event data and one register outputs event data in parallel.

6. A driver circuit in accordance with claim 5, comprising a FIFO controller for maintaining circular read and write pointers to the at least three registers, for selectively enabling and disabling read and write modes of the registers.

7. A driver circuit in accordance with claim 5, further comprising a synchronization input for receiving a sync pulse each n clock cycles, wherein the event timing data is arranged to control timing of event outputs within a range greater than n, such that event data for different actuators may be output from different registers in a given sync cycle.

8. A driver circuit in accordance with claim 1, wherein the parallel output comprises a channel for each actuator, each channel comprising a parallel output and at least one digital-to-analog (D/A) converter for converting the parallel channel output to an analog signal for driving at least one piezo-electric actuator of the array of ink jet actuators.

9. A driver circuit in accordance with claim 8, wherein each channel comprises at least first and second parallel outputs and at least first and second D/A converters, the first parallel output and D/A converter for converting actuator clip level data and the second parallel output and D/A converter for converting actuator current or slew rate.

10. A driver circuit in accordance with claim 8, further comprising a demultiplexer for demultiplexing predetermined output bits of each channel to provide control signals for that channel.

11. A driver circuit in accordance with claim 10, wherein the control signals include signals to drive a channel output to one of high-voltage, low-voltage and high-impedance.

12. A driver circuit in accordance with claim 11, wherein the control signals further include a signal to drive the channel output to at least one intermediate voltage between the high and low voltages.

13. A driver circuit for driving an array of inkjet printer actuators, comprising: a programmable circuit part and a fixed circuit part, the programmable circuit part comprising an input for receiving print data, storage means for storing selectable pre-programmed waveforms in the form of event and timing data, and an output for outputting event and time data pairs based upon the print data and the pre-programmed waveforms; and the fixed circuit part comprising a register for receiving and storing the event and time data pairs, a parallel output for outputting event data, and control circuitry for controlling the timing of output of event data according to corresponding event timing data.

14. A driver circuit for driving an array of inkjet printer actuators, comprising: a programmable circuit part comprising an input for receiving print data; storage means for storing selectable pre-programmed waveforms in the form of event and timing data; and an output for outputting event and time data pairs based upon the print data and the pre-programmed waveforms.

15. A driver circuit for driving an array of inkjet printer actuators, comprising; a register for receiving and storing event and time data pairs; a parallel output for outputting event data; and control circuitry for controlling the timing of output of event data according to corresponding event timing data.
